(19) United States
(12) Patent Application Publication
(10) Pub. No.: US 2025/0382190 A1
(43) Pub. Date: Dec. 18, 2025

(54) PRODUCTION OF AMMONIA FROM SYNTHESIS GAS WITH A LARGE RANGE OF PLANT LOADS

(71) Applicant: Topsoe A/S

(72) Inventors: Raul MONTESANO LOPEZ, Kgs. Lyngby (DK); Louise Jivan SHAH, Vedbæk (DK); Peer Thaarup Kjeldgaard CLAUSEN, Humlebæk (DK); Lari Bjerg KNUDSEN, Kastrup (DK)

(73) Assignee: Topsoe A/S, Kgs. Lyngby (DK)

(21) Appl. No.: 18/877,871

(22) PCT Filed: Jun. 22, 2023
(86) PCT No.: PCT/EP2023/067009

§ 371 Date: Dec. 20, 2024

(30) Foreign Application Priority Data
Jun. 24, 2022 (DK) PA202200613

(51) Int. Cl. C01C 1/04; B01J 8/04

(52) U.S. Cl. CPC C01C 1/0417; B01J 8/0496; B01J 2208/00017

(57) ABSTRACT

The present invention relates to operation of exothermic reactors, such as ammonia synthesis converters in an ammonia synthesis plant operating with a large range of plant loads. Embodiments include a method for operating an ammonia synthesis converter, a method for revamping an ammonia synthesis converter, and an ammonia synthesis converter.

The present invention relates to operation of exothermic reactors, such as ammonia synthesis converters in an ammonia synthesis plant. Embodiments include a method for operating an ammonia synthesis converter, a method for revamping an ammonia synthesis converter, and an ammonia synthesis converter.

In an ammonia synthesis plant, hereinafter also referred to as “plant”, that produces ammonia from conventional hydrocarbon feed sources such as natural gas via the Haber-Bosch process, the load, i.e. ammonia synthesis gas feed, in the ammonia synthesis section, e.g. ammonia synthesis loop, of the plant is usually close to full capacity (normal load), varying by a narrow margin of ±15% or ±10% with respect to the design value. In contrast, plants that produce ammonia from renewables feed sources, for instance where the hydrogen in the ammonia synthesis gas is produced by electrolysis of water or steam, experience large variations in load, usually between 5 and 115% or between 5 and 110% with respect to the design value, such as 5-80% of the design value, or 120% or 125% of the design value. These large variations are associated with the intermittency of the renewable power e.g. solar, wind, or hydropower, required in the electrolysis of water and/or steam to obtain the reactants of the ammonia synthesis gas, particularly hydrogen. The ammonia synthesis gas comprises a mixture of hydrogen and nitrogen, suitably in the molar ratio 3:1. For this reason, an ammonia synthesis converter, hereinafter also referred to as “ammonia converter” or simply “converter”, that is designed for the conditions that prevail when the renewable power input is at its maximum, will be very oversized when e.g. only 5% of the power is available. An oversized converter implies very low space velocities in the converter so that the gas mixture approaches equilibrium after passing over a small fraction of the catalyst bed arranged in the converter.

In adiabatic converters this means that the entire heat of reaction is released close to the inlet, hence most of the catalyst volume is exposed to the highest, i.e. the equilibrium temperature. In non-adiabatic catalyst beds of an ammonia converter, where the ammonia synthesis gas, this being the feed gas, is used to cool the catalyst bed, such as in applicant's WO 2019121949 A1, the temperatures are also higher at reduced loads compared to full capacity and thereby with respect to design value. This is partly because at low flow rates the feed gas is preheated to higher temperatures, and partly because lower linear velocities result in less efficient cooling of the catalyst bed, i.e. low heat transfer coefficients. In the case of e.g. ammonia synthesis, which is exothermic, high temperatures in a catalyst bed mean low conversions into ammonia as well as high catalyst deactivation rates due to often irreversible thermal sintering. In fact, the main cause of irreversible deactivation of industrial ammonia synthesis catalysts is sintering, which is the thermally-driven growth of the metal nanoparticles that constitute the catalyst. Promoted iron catalysts obtained from magnetite, which are the most widely used in industry, exhibit noticeable sintering when exposed to temperatures close to 500° C. for a prolonged time, such as in the order of months. Iron-based catalysts obtained from wustite (FeO) are even more susceptible, exhibiting significant deactivation after some days of exposure to temperatures above 450° C. Sintering also affects supported materials, such as ruthenium-based catalysts.

US 2004/0096370 discloses a split-flow vertical ammonia converter.

The above-mentioned applicant's WO 2019121949 A1 discloses also the use of a split-flow ammonia converter in which a fixed-bed catalyst zone is configured into two or more mechanically separated catalyst volumes and two or more gas streams operating in parallel. Applicant's WO 2019121951 discloses an adiabatic axial flow converter, in which process gas passes from an outer annulus via a catalyst bed, wherein the process gas is converted to a product, to an inner center tube, the catalyst bed comprises at least one module comprising one or more catalyst layers.

However, these citations are at least silent on controlling overheating of catalyst beds in the converter and more generally on how to cope with drastically reduced or increased loads in the plant and thereby in the process gas passed through the converter.

WO 200907018, U.S. Pat. Nos. 1,704,214, 2,512,586, 4,180,543, and 3,186,935 describe reactors with quench designs operated in a way that some of the quench streams are open or closed in order to control the space velocity. These citations do not address the problem of drastically reduced or increased loads in a plant and thereby in the process gas passed through the reactor, e.g. converter. Further, these citations are at least silent on the provision of catalyst modules (catalyst baskets) having no fluid communication between them.

The present application provides therefore a method that enables mitigating excessive temperatures in the catalyst bed of an ammonia converter at varying loads, particularly at low loads, such as 40% load or below, for instance 30%, 20%, 10% or 5% load, with respect to full capacity, i.e. normal load.

More generally, the present application provides a method for operating a reactor performing exothermic catalytic reactions, a method for revamping an ammonia synthesis converter, and an ammonia synthesis converter.

The present invention provides also a simple solution to the challenges posed by the use of intermittent sources for producing the ammonia synthesis gas.

Other benefits of the present application will become apparent from the below description.

Accordingly, in a general embodiment of a first aspect of the invention, there is provided a method for operating a reactor performing exothermic catalytic reactions, the reactor comprising within a single pressure shell: at least two catalyst modules arranged in stacked order and with no fluid communication in between said at least two catalyst modules, the total number of catalyst modules defining a number “N”, and each catalyst module containing one or more catalyst zones arranged in series;
the method comprising:
i) under normal load, defined by continuous operation of the reactor in which a process gas being directed therethrough varies by a margin of ±15% with respect to the design value of the reactor:
supplying the flow of process gas by directing the entire process gas or a portion thereof through a number “n” of the catalyst modules, in which “n” is equal to or less than “N” (n≤N);
and
ii) under varying load, defined by the transient or continuous operation of the process gas in which the process gas being directed therethrough varies by a margin of more than ±15% with respect to the design value of the reactor, interrupting or admitting i.e. introducing the flow of process gas to at least one of the catalyst modules by:
   ii-1) supplying the flow of process gas by directing the entire process gas or a portion thereof through a number “m” of the catalyst modules, in which “m” is less than “n” and higher than 0 (0<m<n);
   or
   ii-2) supplying the flow of process gas by directing the entire process gas or a portion thereof through a number “m” of the catalyst modules, in which “m” is equal to or higher than “n” (m>n) when “n” is less than “N”.

As used herein, the term “comprising” may also include “comprising only”, i.e. “consisting of”.

As used herein, the term “suitable” or “suitably” are used interchangeably with the term “optional” or “optionally”, which means an optional embodiment.

As used herein, the term “first aspect of the invention” or simply “first aspect” means the method of operating a reactor performing exothermic catalytic reactions. The term “second aspect of the invention” or simply “second aspect” means a method for revamping an ammonia synthesis converter. The term “third aspect of the invention” or simply “third aspect” means an ammonia synthesis converter.

As used herein, the term “invention” or “present invention” may be used interchangeably with, respectively, the term “application” or “present application”.

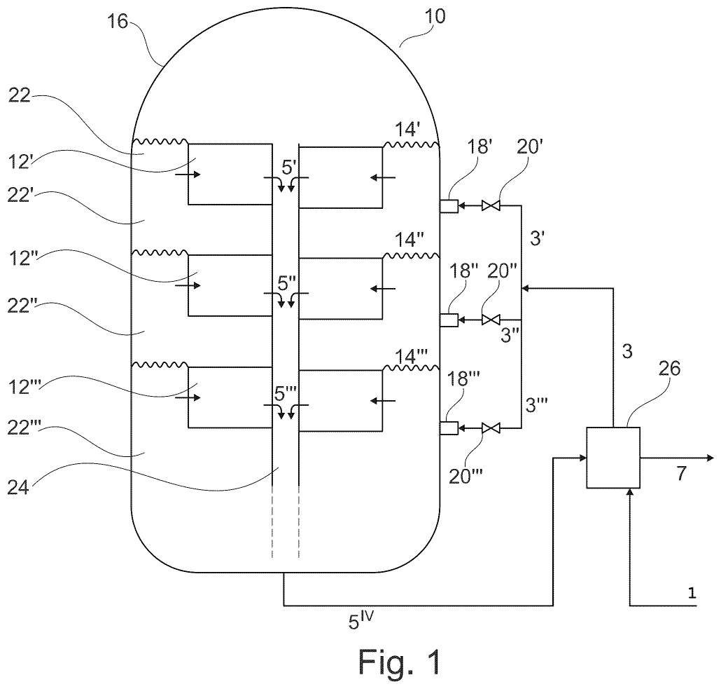

It would be understood that the catalyst modules are arranged in stacked order with no fluid communication between them. Hence, there is no flow running from a catalyst module, such as a first catalyst module, to another catalyst module, such as a second catalyst module; optionally the catalyst modules only share a common outlet, as for instance depicted in appended FIG. 1. The present application provides therefore a mechanism to e.g. stop completely the incoming flow, i.e. said flow of process gas, through a catalyst module.

It would be understood, that under normal load, the reactor runs at loads substantially corresponding to full capacity, varying by a narrow margin of said ±15%, for instance ±10%, with respect to the design value of the reactor, i.e. the process gas being directed therethrough is 85-115% of the design value of the reactor, for instance 90%, 95%, 100%, 105%, 110% of the design value of the reactor.

It would be understood that under varying load, the reactor runs at loads significantly different from normal load and thus from full capacity, varying by a broad margin of said more than ±15%, i.e. the process gas being directed therethrough is for instance 5-80% of the design value of the reactor, or for instance 120% or 125% of the design value of the reactor.

It would be understood that while “n” and “N” is the same for i), ii-1) and ii-2), “m” in ii-1) may be different from “m” in ii-2).

For instance, with reference to appended FIG. 1 illustrating the invention, N=3. In step i) under normal load, process gas is supplied to two catalyst modules, hence n=2 (n<N). It is thus hereby assumed, for illustration purposes, that two catalyst modules are sufficient for normal operation. A sudden increase in load occurs that requires introducing the flow of process gas to all the catalyst modules to restore normal operation, thus ii-2) is conducted in which m=3 (m>n).

Situations are more often encountered where there is a sudden reduction in load. For instance, with reference to the appended FIG. 1, three catalyst modules are provided, hence N=3. In step i) under normal load, process gas may be supplied to the three catalyst modules, hence n=3 (n=N). A sudden reduction in load occurs, so in ii-1) under varying load, the flow of process is interrupted by the process gas being supplied to one catalyst module, hence m=1 (0<m<n).

Situations are also encountered where there is sudden reduction in load followed later by an increase in load. For instance, with reference to the appended FIG. 1, three catalyst modules are provided, hence N=3. In step i) under normal load, process gas may be supplied to the three catalyst modules, hence n=3 (n=N). A sudden reduction in load occurs, so in ii-1) under varying load, the flow of process is interrupted by the process gas being supplied to one catalyst module, hence m=1 (0<m<n). Then, an increase in load occurs that requires introducing the flow of process gas to all the catalyst modules to restore normal operation, thus ii-2) is conducted with m=3 (m=n=N).

For instance, with reference to the appended FIG. 1, three catalyst modules are provided, hence N=3. In step i) under normal load, process gas is supplied to two catalyst modules, hence n=2 (n<N). It is thus hereby assumed, for illustration purposes, that two catalyst modules are sufficient for normal operation. A sudden reduction in load occurs, so in step ii-1) under varying load, the flow of process gas is interrupted by the process gas being supplied to one catalyst module, hence m=1 (0<m<n). Then, an increase in load occurs that requires introducing the flow of process gas to all the catalyst modules to restore normal operation, thus m=3 (m>n).

Accordingly, in an embodiment, ii-2) is conducted after ii-i); ii-1) is conducted when the reactor goes from said normal load (i) to a lower load, i.e. lower load with respect to normal load; and ii-2) is conducted when the reactor goes from a lower load to said normal load (i) or to a high load, where high load is defined as being above 15% with respect to normal load, and in which “m” is equal to or higher than “n” (m≥n) when “n” is equal to or less than “N” (n≤N), more specifically in which “m” is equal to “n” when “n” is equal to “N” (m=n=N).

Hence, ii-1) and ii-2) are conducted sequentially, thereby encompassing instances where in ii-2) m=n=N. Another general embodiment according to the first aspect of the invention may thus be recited as a method for operating a reactor performing exothermic catalytic reactions, the reactor comprising within a single pressure shell: at least two catalyst modules arranged in stacked order and with no fluid communication in between said at least two catalyst modules, the total number of catalyst modules defining a number “N”, and each catalyst module containing one or more catalyst zones arranged in series; the method comprising:
i) under normal load, defined by continuous operation of the reactor in which a process gas being directed therethrough varies by a margin of ±15% with respect to the design value of the reactor:
supplying the flow of process gas by directing the entire process gas or a portion thereof through a number “n” of the catalyst modules, in which “n” is equal to or less than “N” (n≤N);
and
ii) under varying load, defined by the transient or continuous operation of the process gas in which the process gas being directed therethrough varies by a margin of more than ±15% with respect to the design value of the reactor, interrupting or admitting i.e. introducing the flow of process gas through at least one of the catalyst modules by:
   ii-1) supplying the flow of process gas by directing the entire process gas or a portion thereof through a number “m” of the catalyst modules, in which “m” is less than “n” and higher than 0 (0<m<n);
   and
   ii-2) supplying the flow of process gas by directing the entire process gas or a portion thereof through a number “m” of the catalyst modules, in which “m” is equal to or higher than “n” (m>n) when “n” is equal or less than “N” (n≤N).

In an embodiment, in ii) under varying load, the process gas is between 5 and 115% or more of the design value of the reactor. Hence, under varying load and transient operation of the process gas, the process gas may also be 85-115% of the design value of the reactor, such as 90-110%. For instance, the process gas may be in a transition where it rapidly increases from a low load of say 10% to full capacity (normal load) and thus the process gas reaching e.g. 90, 95%, 100% of the design value of the reactor.

The design value of the reactor is suitably represented in terms of the space velocity (SV), for instance the design value of the reactor is a space velocity over the first catalyst bed of a catalyst module ranging between 20000 and 50000 Nm³/h/m³, such as in the range 25000-45000 Nm³/h/m³. A low load of e.g. 10% means therefore a SV in the range of e.g. 2500-4500 Nm³/h/m³, i.e. 2500-4500 h⁻¹.

A catalyst module, i.e. a catalyst basket, is an assembly containing one or more catalyst beds. The catalyst module is also simply referred herein as “module”.

As used herein, the term “low load” means 70% or below, such as 60%, 50%, 40%, 30%, 20%, 10% or 5% load, with respect to full capacity (normal load). The percentages are with respect to the design value of the reactor.

As used herein, the term “high load” means +15% or higher such as +20% with respect to full capacity (normal load); hence the process gas being directed through the reactor is e.g. 120% of the design value of the reactor. For instance, if SV is 25000 Nm³/h/m³ a high load of +20% means 30000 Nm³/h/m³. It would be understood that ±15% means within 15%, thus including 15%; while +15% means above 15% thus excluding 15%. It should thus be understood that said +20% means 20% or higher, i.e. +20% includes here 20%.

A load in between a “low load” and a “high load” may thus be regarded as being intermediate, i.e. an intermediate load. For instance, an intermediate load is 75%, 80% load, with respect to full capacity (normal load). It would be understood that a 85%, 90%, 95%, 100%, 105%, 110%, 115% load, is a normal load. The percentages are with respect to the design value of the reactor.

As used herein, the term “lower load” means lower load with respect to full capacity (normal load), thus for instance 80%, 75%, as well as for instance also 70% or below, such as 60%, 50%, 40%, 30%, 20%, 10% or 5% load, with respect to full capacity (normal load). The term “lower load” encompasses therefore any of said intermediate low or said low load. The percentages provided herein are with respect to the design value of the reactor.

For the purposes of the present application, when percentages of load are provided, these are with respect to the design value of the reactor, unless already specifically recited as such.

Hence, the invention provides a method for mitigating excessive temperatures in the catalyst bed at particularly low loads by using two or more catalyst modules, herein also referred to as catalyst baskets, that may operate in parallel within the same pressure shell, by supplying the process gas flow through some or all of the catalyst modules depending on loading conditions, i.e. under normal load or under varying load. For instance, in i) by said supplying of the flow of process gas being by admitting i.e. introducing the process gas flow through all catalyst modules under normal load (n=N); in ii-1) by said supplying of the flow of process gas being by interrupting, e.g. stopping, the process gas flow through only some of the catalyst modules, when the reactor goes from normal load to low load such as down to 10% or 5% load (e.g. m<n); and/or in ii-2) by said supplying of the flow of process gas being by admitting i.e. introducing the process gas flow through all catalyst modules again, when the reactor goes from low load to normal or high load (e.g. m>n).

In an embodiment, the reactor is an ammonia synthesis converter, and the process gas is ammonia synthesis gas.

At low loads, the flow of process gas through some of the modules can be stopped, forcing the feed gas, e.g. ammonia synthesis gas being fed, to pass only through the modules that remain open. In this way the space velocity through the converter can be adjusted depending on the plant load and the overheating of the catalyst can be controlled. More specifically, the total flow of the ammonia synthesis gas is divided among the catalyst modules so that they operate in parallel; then the flow through one or more catalyst modules is stopped, forcing the process gas to pass over those catalyst modules that remain open, thereby increasing the space velocity.

For the purposes of the present application, the terms “feed gas”, “process gas” and “ammonia synthesis gas” may be used interchangeably.

A modular converter may for instance consist of fixed catalyst beds placed in catalyst modules that are contained within a single pressure shell. The catalyst volume in the modules may or may not be identical and the modules can be stacked on top of each other in a vertical configuration or placed next to each other in a horizontal configuration. The catalyst beds can be adiabatic, gas-cooled or a combination of these. The inlet gas to the converter may be divided so that a fraction of the flow passes through each of the modules (i.e. the modules operate in parallel). An example of a modular converter is the converter of the above-mentioned applicant's WO 2019121949 A1.

A distinctive feature of the present application is that the flow of process gas through one or more catalyst modules can be stopped by blocking either the inlet or the outlet to the modules. Hence, the gas is forced to flow through the modules that remain open thereby increasing the space velocity. As a result, the average temperature in the open catalyst modules is lower than what would be observed if the same inlet flow of process gas was passing over all the catalyst modules. Likewise, the catalyst modules that remain closed will be exposed to lower temperatures than the maximum temperature obtained if they were on stream. The mode of operation here described mitigates the overheating of the catalyst charge increasing its lifetime.

In an embodiment, in i) n=N, thereby in i) passing the entire process gas or a portion thereof through all the catalyst modules. Hence, under normal load where the reactor operates at full capacity and thus with a very narrow margin of ±15%, such as ±10% with respect to the design value of the reactor, the process gas is admitted by passing through all the catalyst modules. For instance, the converter is provided with a total of six (6) catalyst modules (N=6) and where the process gas under varying load is admitted to all the catalyst modules, then n=N=6.

While the above represents an instance of the normal operation of the reactor, e.g. the ammonia synthesis converter, where all catalyst beds are used, for instance when there is a variation of +5% with respect to the design value of the reactor, there may be instances where the reactor operates under normal load yet where the process gas is admitted to not all of the catalyst modules, thus n<N. For instance, if the reactor operates at −10% with respect to the design value of the reactor, i.e. at 90% load (90% of the design value of the reactor), while the reactor may be provided with six catalyst modules (N=6), the process gas may be admitted to only five catalyst modules, thus n=5.

The change into operation under varying loads may be abrupt, i.e. sudden, for instance within few minutes such as a variation of 2-5% per minute in the range 5-100% load., The sudden variation in load may not only result in low loads such as 10% or 5% with respect to the design value of the reactor, but also loads significantly above the design value such as 115% or more. In the former when for instance there is no wind or solar generated power, or in the later where there is an excess of wind or solar generated power.

Hence, in a particular embodiment, N=6, n=6 and m=1, thus only one catalyst module is used (open) and five catalyst modules are not used (closed), when there is a sudden change into the so-called varying load, where e.g. the process gas being directed through the reactor is 10% of the design value. Example 1 farther below illustrates this embodiment.

In another particular embodiment, N=6, n=5 and m=1, thus again only one catalyst module is used when there is a sudden change into the so-called varying load, where e.g. the process gas being directed through the reactor is 5% of the design value, yet under normal operation instead of using all catalyst module (N=6), the reactor may be operated with one less catalyst module (n=5).

In yet another particular embodiment, N=6, n=5 and m=6, thus again when changing from a normal operation using one catalyst module less than all the catalyst modules provided in the reactor (n<N, m=5, N=6), now all catalyst modules are used (m=6) when there is a sudden change into the so-called varying load, where e.g. the process gas being directed through the reactor is 115% of the design value.

Other particular embodiments may be envisaged, for instance N=3, n=3, m=1, as illustrated in connection with Example 2

The solution provided by the present application is superior than the prior art by at least the following reasons:
In conventional ammonia synthesis plants, the inlet temperature to the catalyst bed of an ammonia synthesis converter is controlled by adjusting the bypass ratio in the heat exchangers used to preheat the feed. This feature may also be available in ammonia synthesis converters according to the present patent application. However, there is a limit on how much the inlet temperature to the catalyst bed can be lowered, which is given by the onset of the catalytic activity, usually not less than 350° C. For very low loads, e.g. 10% or 5%, the applicant has found out that such controlling of the inlet temperature is not sufficient to avoid overheating of a significant part of the catalyst, as further illustrated in the Examples section farther below.
Another straightforward option is to change the composition of the feed gas to the reactor by increasing the amount of nitrogen therein so that the ratio H₂:N₂ is lower than the normal desirable ratio of 3. Thereby the feed gas becomes less reactive and the overheating in the catalyst bed may be reduced. This however, conveys the risk of tripping the feed gas compressor as this is normally designed to operate within a very narrow range of said ratio H₂:N₂=3. Furthermore, this also makes the response of the ammonia synthesis loop sluggish, since if the desired ratio H₂:N₂ of 3 is suddenly needed, it will take some time to purge the excess nitrogen present in the loop.

Hence, the present application enables to cope with a wider range of loads, and in particular very low loads, such as 10%, 5% or even less with respect to the design value of the reactor. This is important, as the loads easily change from one extreme to the other, e.g. one day the load may be close to 100%, thus near normal load, for instance where there are strong winds driving the wind turbines for generating the electricity required for electrolysis of water or steam to hydrogen, while later in the same day or the next day, there may be low wind or even no wind at all so the wind turbines are not generating any electricity, and thereby drastically reducing the load to e.g. down to 5%. The next day the wind or solar power may pick up and the load will vary to low load, e.g. 5% to a high load, such as 115% or 120% (margin of +15% or +20%) with respect to the design value of the reactor.
Another alternative used in industry is to install two or more converters operating in parallel and bring them on and off-stream depending on the load available in the ammonia synthesis loop. This solution involves many converters, each one contained in its own pressure shell. The converters typically include one or more catalyst fixed beds arranged in series with interbed cooling.
The possibility of adjusting the space velocity through the catalyst beds in accordance with the present invention, lessens the non-reversible deactivation of the catalyst charge when the plant load is reduced and thereby the converter operates under varying load. This is because the overheated regions that undergo faster sintering are confined to smaller volumes within the catalyst modules that remain open. The catalyst in the modules off-stream is exposed to lower temperatures and the deactivation through sintering is not significant.

The present application provides a mechanism to completely stop the flow through one or more catalyst modules when there is a reduction in the load.

The present application allows to have parallel operation of catalyst modules (catalyst baskets) placed within a single pressure shell, regardless of the type of converter being used, hence regardless of whether the converter is of the type described in applicant's WO 2019121949 A1 where the process gas is provided in parallel to the catalyst baskets; or a converter where the process gas is provided in series to the catalyst baskets, and where the typical solution has been the provision of parallel-arranged reactors each with its own pressure shell. The present invention enables having only one pressure shell which is the most expensive item in an ammonia converter

The invention provides therefore high flexibility during operation and significantly reduces the investment costs and operating costs for clients.

The ammonia converter is capable to operate at continuous operation i.e. steady-state or near steady-state, herein referred to as transient or continuous operation, where there is a normal load, and at transient conditions or continuous where there is e.g. a sudden change in the load to e.g. down to 10% load, and the load is sustained at such 10% load for a significant number of hours or days—thus the reactor being in continuous operation.

In an embodiment, the process gas passes in axial and/or radial flow direction through the at least two catalyst modules, e.g. through a first catalytic set. In another embodiment, the at least two catalyst modules are operated in parallel, i.e. in parallel with respect to the process gas. Thereby, there is high flexibility in the operation of the reactor.

The present application surprisingly provides a parallel operation approach in an already parallel operation i.e. whereby the catalyst modules operate in parallel. For instance, a first catalyst module operates by the flow of a portion of the process gas being directed therethrough, while a second catalyst module operates independently in which the flow of another portion of the process gas is directed therethrough. This is significantly different than for instance the parallel approach of applicant's WO 2019121949 A1, where the catalyst modules are operated in parallel with respect to the process gas, yet not independently.

In an embodiment, the catalyst modules are operated adiabatically; or the catalyst modules are operated non-adiabatically, for instance by being gas-cooled, such as by the cooling with the process gas being directed to the reactor; or a first catalytic zone of a catalyst module is operated non-adiabatically, and a subsequent serially arranged catalytic zone of the catalyst module is operated adiabatically.

This enables further reducing catalyst degradation by being able to adjust how many modules are used for different process gas flows as well as keeping the exothermic reaction, e.g. conversion of hydrogen and nitrogen in the ammonia synthesis gas (process gas) into ammonia, close to equilibrium, since the space velocity is maintained high for the modules in use and the temperature is kept low for favouring the thermodynamics of the exothermic reaction.

The high temperatures that will prevail at particularly low loads throughout the ammonia converters will decrease the lifetime of the catalyst in conventional converter designs, where the catalyst lifetime is usually 15 years. Therefore, the invention enables longer catalyst lifetimes, as the catalyst becomes less prone to sintering due to exposure to the high temperatures.

The present application is also highly useful for revamping ammonia converters, since relatively minor modifications may be provided to existing converters, yet with a significant impact in terms of coping with varying loads and attendant problems, as explained above.

Accordingly, in a second aspect of the invention, there is provided a method for revamping an ammonia synthesis converter, the ammonia synthesis converter comprising within a pressure shell:
at least two parallel operated catalyst modules arranged in stacked order, each containing in series one or more catalyst zones with a catalyst layer adapted to axial and/or radial flow; an outer annular space between the at least two parallel operated catalyst modules and the pressure shell, in which the outer annular space is fluidly connected to the at least two parallel operated catalyst modules;
an inlet arranged in the pressure shell for directing ammonia synthesis gas through the outer annular space;
an outlet arranged for receiving a product gas from the at least two parallel catalyst modules, the outlet optionally being arranged in a space formed centrally, i.e. a central space, within the at least two stacked catalyst modules;
the method comprising:
installing one or more seals in the outer annular space, the one or more seals being in direct contact with the pressure shell and one or more, respectively, of the at the at least two parallel operated catalyst modules; in which a first seal is installed in between the pressure shell and the first of the at least two parallel catalyst modules, thereby defining a first outer annular space; and a second seal is installed between the pressure shell and the second of the at least two parallel catalyst modules, thereby defining a second outer annular space;
installing a plurality of inlets for independently directing the ammonia synthesis gas through the first or second outer annular space; in which a first inlet is arranged in direct fluid communication with the first outer annular space,, optionally in direct fluid communication with the first outer annular space; and a second inlet is arranged in fluid communication with the second outer annular space, optionally in direct fluid communication with the second outer annular space.

It would be understood that there is no fluid communication in between said at least two catalyst modules.

In an embodiment, the method comprises installing the one or more seals at the top of the first and second of the at least two parallel operated catalyst modules. Thereby the process gas is able to enter the whole catalyst module and the installation of the seal can be made in a simple manner to align with the top, e.g. with the lid, of the respective catalyst module.

The seals are hermetic so the respective catalyst modules, where required, are fully closed.

In an embodiment, the seals are annular plates. The seals are hermetic and fit the outer annular space of the converter, thus enabling ease of installation.

In a third aspect of the invention, there is also provided an ammonia synthesis converter comprising within a pressure shell:
at least two parallel operated catalyst modules arranged in stacked order, each containing in series one or more catalyst zones with a catalyst layer adapted to axial and/or radial flow;
an outer annular space between the at least two parallel operated catalyst modules and the pressure shell, in which the outer annular space is fluidly connected to the at least two parallel operated catalyst modules;
one or more seals arranged in the outer annular space, the one or more seals being in direct contact with the pressure shell and one or more, respectively, of the at the at least two parallel operated catalyst modules; in which a first seal is arranged in between the pressure shell and the first of the at least two parallel catalyst modules, thereby defining a first outer annular space; and a second seal is arranged between the pressure shell and the second of the at least two parallel catalyst modules, thereby defining a second outer annular space;
a plurality of inlets for independently directing ammonia synthesis gas through the first or second outer annular space; in which a first inlet is arranged in direct fluid communication with the first outer annular space, and a second inlet is arranged in fluid communication with the second outer annular space;
an outlet for receiving a product gas from one or more of the at least two parallel catalyst modules.

It would be understood that there is no fluid communication in between said at least two catalyst modules.

In modern adiabatic ammonia converters, the space velocities (SV) over the first catalyst bed range between 25000 Nm³/h/m³ and 45000 Nm³/h/m³ whereas the typical inlet temperatures are 350° C.-385° C. The equilibrium temperatures are in the range 495° C.-540° C., depending on the loop pressure (usually 120 bar g-250 bar g) and the concentration of ammonia in the gas (usually 3.0 vol. %-10.0 vol. %). The minimum inlet temperature to the converter is constrained by the necessity of having a significant reaction rate over the catalyst bed. The space velocities are typically selected to obtain an exit temperature 5° C. to 15° C. below the thermodynamic equilibrium.

Hence, as in connection with the first or second aspect of the invention, at varying loads, such as at low loads, the flow of process gas through some of the catalyst modules can be stopped, forcing the feed gas to pass only through the catalyst modules that remain open. In this way the space velocity through the converter can be adjusted depending on the plant load, thereby on amount of process gas being directed through the converter, and the overheating of the catalyst can be controlled. Hence, the converter of the present invention enables controlling the space velocity in the converter by admitting or stopping the gas flow through some of the catalyst modules.

In an embodiment, the outlet is arranged in a space formed centrally within the at least two stacked catalyst modules; i.e. the outlet is arranged in a central space of the ammonia synthesis converter. Thereby, product gas (ammonia containing gas) is collected in a simple manner and allowed to exit the converter at a single outlet arranged in the converter pressure shell and which can be used for preheating the process gas entering the converter. The preheating may be conducted in a feed/effluent heat exchanger arranged within the pressure shell of the converter (internal heat exchanger) or outside the pressure shell (external heat exchanger).

In an embodiment, the one or more seals are annular plates and arranged at the top of the first and second of the at least two parallel operated catalyst modules. As recited previously, the process gas is thereby able to enter the whole catalyst module and the installation of the seal can be made in a simple manner to align with the top, e.g. with the lid, of the respective catalyst module.

In an embodiment, the converter further comprises:
covers, such as lids, closing the at least two parallel operated catalyst modules;
an intrabed heat exchanger for cooling the catalyst layer in the at least one of the catalyst zones; the intrabed heat exchanger comprising an inlet and an outlet; and
in the at least one cooled catalyst zone, the ammonia synthesis converter comprises feed means for conducting ammonia synthesis gas into the inlet of the intrabed heat exchanger, in which the inlet of the intrabed heat exchanger is fluidly connected to the first outer annular space or second outer annular space; the outlet of the intrabed heat exchanger is optionally fluidly connected with a feed means such as conduit for directing the thus pre-heated ammonia synthesis gas together with fresh ammonia synthesis gas into the inlet of the at least one of the catalyst zones.

In an embodiment, at least one of the serial catalyst zones is an adiabatic catalyst zone, and a single cooled catalyst zone is connected in series with a single adiabatic catalyst zone. Thereby, within a single catalyst basket there is provided first a cooled zone, thus non-adiabatic, and subsequently an adiabatic zone where there is no heat exchange. Better control of the reaction temperature is obtained in this manner.

It would be understood that any of the embodiments and associated benefits of the first aspect of the invention may be used together with any of the embodiments and associated benefits of the second or third aspect of the invention, or vice versa.

FIG. 1 is a simplified cross section of an ammonia converter according to the present invention showing three catalyst modules, operating in parallel inside a single (common) pressure shell.

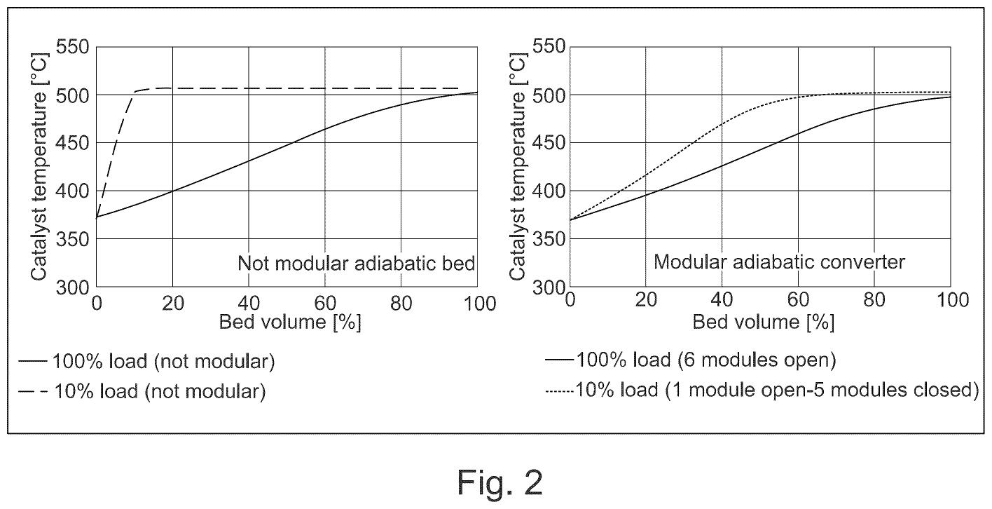

FIG. 2 corresponds to Example 1 and shows the performance of an ammonia converter consisting of one single adiabatic bed in accordance with the prior art (e.g. applicant's ammonia converters according under the name S-100 and S-50, as well-known in the art), compared against the performance of a modular reactor having six catalyst baskets operating in parallel in accordance with an embodiment of the present invention.

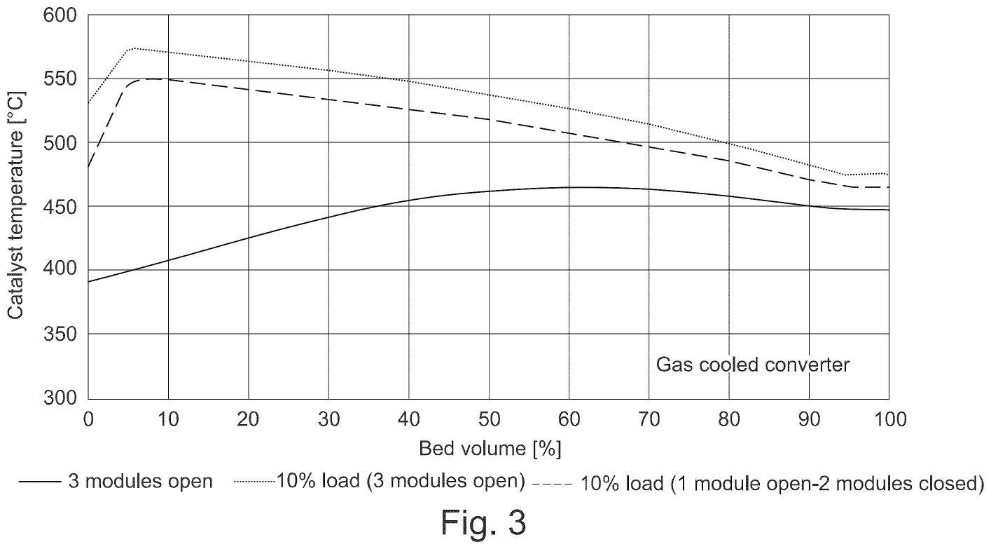

FIG. 3 corresponds to Example 2 and shows the performance of an ammonia converter consisting of three modules with intrabed gas cooling in accordance with an embodiment of the present invention.

With reference to FIG. 1, ammonia converter 10 having a pressure shell 16 comprises also three parallel operated catalyst modules 12 (12′, 12″, 12′″) arranged in stacked order. Each of the catalyst modules contains in series one or more catalyst zones with a catalyst layer adapted to for instance radial flow of process gas, here ammonia synthesis gas. An outer annular space 22 (22′, 22″, 22′″) is defined between the parallel operated catalyst modules 12 (12′, 12″, 12′″) and the pressure shell 16. The outer annular space 22 is fluidly connected to the parallel operated catalyst modules 12. Seals 14 (14′, 14″, 14′″) are arranged in the outer annular space 22, for instance as annular plates at the top of the catalyst modules 12. The seals 14 are in direct contact with the pressure shell 16 and the corresponding parallel operated catalyst modules 12. Thus, for instance, seal 14′ is arranged in direct contact with the pressure shell 16 and the catalyst module 12′, as illustrated. Thereby, there is defined a first outer annular space 22′. A second seal 14″ is arranged between the pressure shell 16 and the second 12″ of the parallel catalyst modules, thereby defining a second outer annular space 22″. A third seal 14′″ is arranged between the pressure shell 16 and the third 12′″of the parallel catalyst modules, thereby defining a third outer annular space 22′″. The converter 10 comprises a plurality of inlets 18 (18′, 18″, 18′″), for example via nozzles on the pressure shell 16 and corresponding valves 20 (20′, 20″, 20′″), for independently directing the ammonia synthesis gas 1, 3 (3′, 3″, 3′″) through the first (22′) or second (22″) or third (22′″) outer annular spaces. A first inlet 18′ is arranged in direct fluid communication with the first 22′ outer annular space, a second inlet 18″ is arranged in fluid communication with the second 22″ outer annular space, and a third inlet 18′″ is arranged in fluid communication with the third 22′″ outer annular space. The converter 10 comprises also an outlet such as conduit 24 arranged for receiving a product gas 5′, 5″, 5′″ from the catalyst modules 12, which leaves the pressure shell 16 as product gas stream 5^{iv}. The outlet 24 is arranged in a space formed centrally within the catalyst modules 12, i.e. in a central space. Ammonia synthesis gas 1 is introduced to the converter 10 by first preheating it in an external feed/effluent heat exchanger 26, using the hot product gas (ammonia product) 5^{iv} as the heat exchanging medium, the latter thus being cooled and exiting as stream 7. The preheated ammonia synthesis gas 3 is then split into streams 3′, 3″, 3′″ and introduced to the converter 10. The flow of ammonia synthesis gas 3 may be admitted or interrupted depending on the plant load. At normal load all valves 18′, 18″, 18′″ may be open so that the ammonia synthesis gas 3 is allowed to pass through all, here three, catalyst modules 12. When there is varying load, in particular at low load, for instance 10% load, the flow of ammonia synthesis gas 3 to the first 12′ and second 12″ catalyst modules is interrupted and only admitted to the third 12′″ catalyst module, as stream 3′″ via inlet 18′″. It would thus be understood that the catalyst modules 12 (12′, 12″, 12′″) are arranged in stacked order with no fluid communication between them. The corresponding sections 12′ and 22′; 12″ and 22″; 12′″ and 22′″, as depicted in the figure only share a common outlet 24. There is no fluid communication in between the catalyst modules. Further, there is independent operation of the catalyst modules and thus the corresponding sections. The present application provides a mechanism to stop completely the flow through one or more of the catalyst modules.

### EXAMPLES

### Example 1

In FIG. 2, the performance of an ammonia converter consisting of one single adiabatic bed, thus not modular adiabatic bed converter (e.g. applicant's S-100 or S-50, as mentioned above; left hand side of the figure) is compared against the performance of a modular adiabatic converter according to an embodiment of the present invention having six catalyst modules (catalyst baskets) operating in parallel (right hand side of the figure). The ammonia synthesis gas, i.e. feed gas, contains 70.40 vol. % H₂, 23.46 vol. % N₂, 4.13 vol. % NH₃ and 2.01 vol. % inerts, and the converter operates at 138.1 bar g with a space velocity (SV) at full capacity (100% load) of 45000 Nm³/h/m³. Thus, the design value of the converter is here SV=45000 Nm3/h/m3. These process conditions are representative of a plant producing ammonia from renewable sources.

At 100% load, the performances of the single not modular adiabatic bed converter and the modular adiabatic converter are identical, with the converter (reactor) temperature exceeding 490° C. only in the last about 20% of the catalyst volume. However, at 10% load, thus at 10% of the design capacity (thus now SV=4500 Nm³/h/m³) and still utilizing all catalyst modules, the large excess of catalyst in a single adiabatic bed results in 95% of the catalyst volume exposed to temperatures above 490° C. If the periods with low load are recurrent and/or sustained, a significant, and irreversible, loss of catalytic activity will be evident after just a few years of operation. See left-hand side of FIG. 2.

In contrast, as shown in the right-hand side of FIG. 2, in a converter with six catalyst baskets in parallel (N=6, n=6), the flow can be admitted through only one of the modules (m=1) when the plant load is 10%. If the six modules are equal in size, the space velocity over the open basket is 27000 Nm³/h/m³. Then the volume of catalyst heated above 490° C. is only 50% of one of the beds, i.e. approximately 8% of the total catalyst charge.

### Example 2

In FIG. 3, the performance of a converter according to applicant's WO 2019121949, consisting of three modules (N=3) with intrabed gas cooling is presented. Two cases are compared: 1) at high and low loads the three modules (N=3) are on stream and thus open; and 2) the flow through two of the modules can be stopped (N=3, m=1) so that at low loads, here 10% load, the inlet passes only over one third of the catalyst available. The feed gas contains 61.28 vol. % H₂, 21.21 vol. % N₂, 6.26 vol. % NH₃ and 11.25 vol. % inerts. The converter operates at 224.0 bar g with a space velocity at full capacity, i.e. normal load, of 37750 Nm³/h/m³. Thus, the design value of the converter is here SV=37750 Nm³/h/m³. The inlet temperature to the cooling plates for the intrabed gas cooling is 297° C. These process conditions are representative of a plant producing ammonia from renewable sources.

At 100% load, with the three modules open (thus N=3, n=3, m=0), the reactor temperature is well below 490° C. throughout the entire catalyst volume, as shown by the lower solid line of the figure. However, at a varying load of 10% of the design capacity (thus now SV=3775 Nm³/h/m³), about 85% of the catalyst volume (bed volume) is exposed to temperatures above 490° C. if all the modules are in operation (thus N=3, n=3, m=0), as shown in the top line of the figure. Now, in a converter under a varying load of 10% yet in which the flow is admitted through only one of the modules (thus N=3, n=3, m=1), the space velocity over the open basket is 11325 Nm³/h/m³ at 10% load, if the volume of the three modules is identical. Then the volume of catalyst heated above 490° C. is only 75% of one of the beds which corresponds to approximately 25% of the total catalyst charge.

1.-9. (canceled)

10. A method for revamping an ammonia synthesis converter, the ammonia synthesis converter comprising within a pressure shell:
at least two parallel operated catalyst modules arranged in stacked order, each containing in series one or more catalyst zones with a catalyst layer adapted to axial and/or radial flow;
an outer annular space between the at least two parallel operated catalyst modules and the pressure shell, in which the outer annular space is fluidly connected to the at least two parallel operated catalyst modules;
an inlet arranged in the pressure shell for directing ammonia synthesis gas through the outer annular space;
an outlet arranged for receiving a product gas from the at least two parallel catalyst modules, the outlet optionally being arranged in a space formed centrally within the at least two stacked catalyst modules;
the method comprising:
installing one or more seals in the outer annular space, the one or more seals being in direct contact with the pressure shell and one or more, respectively, of the at the at least two parallel operated catalyst modules; in which a first seal is installed in between the pressure shell and the first of the at least two parallel catalyst modules, thereby defining a first outer annular space; and a second seal is installed between the pressure shell and the second of the at least two parallel catalyst modules, thereby defining a second outer annular space;
installing a plurality of inlets for independently directing the ammonia synthesis gas through the first or second outer annular space; in which a first inlet is arranged in fluid communication with the first outer annular space, and a second inlet is arranged in fluid communication with the second outer annular space.

11. The method according to claim 10, comprising installing the one or more seals at the top of the first and second of the at least two parallel operated catalyst modules.

12. The method according to claim 10, wherein the seals are annular plates.

13. An ammonia synthesis converter comprising, within a pressure shell:
at least two parallel operated catalyst modules arranged in stacked order, each containing in series one or more catalyst zones with a catalyst layer adapted to axial and/or radial flow;
an outer annular space between the at least two parallel operated catalyst modules and the pressure shell, in which the outer annular space is fluidly connected to the at least two parallel operated catalyst modules;
one or more seals arranged in the outer annular space, the one or more seals being in direct contact with the pressure shell and one or more, respectively, of the at the at least two parallel operated catalyst modules; in which a first seal is arranged in between the pressure shell and the first of the at least two parallel catalyst modules, thereby defining a first outer annular space; and a second seal is arranged between the pressure shell and the second of the at least two parallel catalyst modules, thereby defining a second outer annular space;
a plurality of inlets for independently directing ammonia synthesis gas through the first or second outer annular space; in which a first inlet is arranged in direct fluid communication with the first outer annular space, and a second inlet is arranged in fluid communication with the second outer annular space;
an outlet for receiving a product gas from one or more of the at least two parallel catalyst modules.

14. The ammonia synthesis converter according to claim 13, wherein the outlet is arranged in a space formed centrally within the at least two stacked catalyst modules.

15. The ammonia synthesis converter according to claim 13, wherein the one or more seals are annular plates and arranged at the top of the first and second of the at least two parallel operated catalyst modules.

16. The ammonia synthesis converter according to claim 13, further comprising:
covers closing the at least two parallel operated catalyst modules;
an intrabed heat exchanger for cooling the catalyst layer in the at least one of the catalyst zones, thereby defining at least one cooled catalyst zone; the intrabed heat exchanger comprising an inlet and an outlet; and
in the at least one cooled catalyst zone, the ammonia synthesis converter comprises feed means for conducting ammonia synthesis gas into the inlet of the intrabed heat exchanger, in which the inlet of the intrabed heat exchanger is fluidly connected to the first outer annular space or second outer annular space; the outlet of the intrabed heat exchanger is optionally fluidly connected with a feed means for directing the thus pre-heated ammonia synthesis gas together with fresh ammonia synthesis gas to the inlet of the at least one of the catalyst zones.

17. The ammonia synthesis converter according to claim 13, wherein at least one of the serial catalyst zones is an adiabatic catalyst zone, and wherein a single cooled catalyst zone is connected in series with a single adiabatic catalyst zone.
